(19) United States
(12) Patent Application Publication
(10) Pub. No.: US 2019/0055910 A1
(43) Pub. Date: Feb. 21, 2019

(54) High-Pressure Fuel Pump And Fuel Injection System

(71) Applicant: Continental Automotive GmbH, Hannover (DE)

(72) Inventor: Max Scheller, Stamsried (DE)

(73) Assignee: Continental Automotive GmbH, Hannover (DE)

(21) Appl. No.: 16/074,476

(22) PCT Filed: Jan. 20, 2017
(86) PCT No.: PCT/EP2017/051215

§ 371 Date: Aug. 1, 2018

(30) Foreign Application Priority Data
Feb. 3, 2016 (DE) 10 2016 201 600.8

(51) Int. Cl. F02M 55/00; F02M 59/48; F02M 55/02; F04B 19/22

(52) U.S. Cl. CPC F02M 55/005; F02M 59/48; F02M 2200/8076; F04B 19/22; F02M 2200/8053; F02M 55/02

(57) ABSTRACT

Various embodiments may include a fuel pump for applying pressure to a fuel in a fuel injection system comprising: a housing with a pressure chamber; a fluid port for conducting fuel to and/or from the pressure chamber; a port receiving bore in the housing for receiving the fluid port; and a screw drive arranged in the internal bore of the fluid port, via which the fluid port can be acted on in order to be screwed into the port receiving bore. The fluid port has an internal bore fluidically connected to the pressure chamber. The fluid port is fastened in the port receiving bore with a screw connection.

### CROSS-REFERENCE TO RELATED APPLICATIONS

This application is a U.S. National Stage Application of International Application No. PCT/EP2017/051215 filed Jan. 20, 2017, which designates the United States of America, and claims priority to DE Application No. 10 2016 201 600.8 filed Feb. 3, 2016, the contents of which are hereby incorporated by reference in their entirety.

### TECHNICAL FIELD

The present disclosure relates to internal combustion engines and pumps. Various embodiments may include a high-pressure fuel pump for applying high pressure to a fuel in a fuel injection system, and/or a fuel injection system which has such a high-pressure fuel pump.

### BACKGROUND

High-pressure fuel pumps in fuel injection systems are used to apply a high pressure to a fuel, wherein the high pressure is in the range from 150-600 bar in gasoline internal combustion engines and in the range from 1500-3000 bar in diesel internal combustion engines, for example. The greater the pressure which can be generated in the particular fuel, the lower the emissions which arise during the combustion of the fuel in a combustion chamber, this being advantageous in particular against the background of a reduction in emissions being desired to an ever greater extent.

In a typical fuel injection system, the high-pressure fuel pump is fed the fuel via a line, for example via a predelivery pump, and then high pressure is applied thereto in a pressure chamber within a housing of the high-pressure fuel pump. Once high pressure has been applied to the fuel therein, the fuel is again conducted via a line to elements of the fuel injection system that are located downstream of the high-pressure fuel pump, for example what is known as a common rail. The abovementioned lines are in this case connected to the housing of the high-pressure fuel pump via a respective fluid port, namely, on one side, a low-pressure port which connects the pressure chamber fluidically to the line that feeds the fuel to the high-pressure fuel pump, and on the other side, a high-pressure port which is located fluidically downstream of the pressure chamber and conveys the highly pressurized fuel away from the pressure chamber.

The higher the system pressures, i.e. the high pressure generated in the pressure chamber, become, the greater the demands placed on the fluid port fastened to the housing. Therefore, it is typical to use screwed fluid ports rather than conventional welded fluid ports. However, screwed fluid ports have the drawback that they need to be protected from “misuse” in order that, in the installed state of the high-pressure fuel pump, it is not possible to tamper with the fluid port. Therefore, it is known, for example, to use fluid ports which additionally have an adhesive application or comprise extremely high tightening torques in order to create a higher loosening torque. These two previously used solutions are relatively complicated to produce and therefore incur costs.

### SUMMARY

The teachings of the present disclosure may include a high-pressure fuel pump that is improved in this respect. For example, a high-pressure fuel pump (12) for applying high pressure to a fuel in a fuel injection system (10), may include: a housing (14) having a pressure chamber (16) in which high pressure is applied to the fuel; a fluid port (24) for conducting fuel to the pressure chamber (16) or away from the pressure chamber (16), wherein the fluid port (24) has an internal bore (26) which is fluidically connected to the pressure chamber (16); a port receiving bore (30) in the housing (14) for receiving the fluid port (24), wherein the fluid port (24) is fastened in the port receiving bore (30) by a screw connection (28); and a screw drive (44), via which the fluid port (24) can be acted on in order to be screwed into the port receiving bore (30), wherein the screw drive (44) is arranged in the internal bore (26) of the fluid port (24).

In some embodiments, the fluid port (24) is a high-pressure port (38) for guiding fuel, to which high pressure has been applied in the pressure chamber (16), to elements of the fuel injection system (10) that are located downstream of the high-pressure fuel pump (12).

In some embodiments, the fluid port (24) has a contact region (50) for making contact with a wall (52) of the port receiving bore (30) and a line region (54) for forming a line for guiding the fuel, wherein the internal bore (26) forms a collection volume (56) for collecting fuel, in particular highly pressurized fuel from the pressure chamber (16), in the contact region (50), wherein the internal bore (26) forms a line bore (58) in the line region (54), wherein the screw drive (44) is arranged in a manner integrated into the line bore (58).

In some embodiments, in the contact region (50), the fluid port (24) has, on its outer side (32), an external thread (34) for cooperating with an internal thread (36) arranged in the port receiving bore (30), wherein the fluid port (24) is formed with a smooth outer wall without an engagement surface, and in particular in a cylindrical manner, in the line region (54).

In some embodiments, the outer wall has a coating (64) for accommodating torsional forces.

In some embodiments, the screw drive (44) in the internal bore (26) is configured as a polygonal socket, in particular as a hex socket (46), or as a lobular socket, in particular as a hexalobular socket (48).

In some embodiments, an insert (66) has been inserted into the screw drive (44), which has a smooth inner surface (68).

In some embodiments, the housing (14) and the fluid port (24) are fastened together by at least one crimped portion (60) that applies a fastening force to the screw connection (28), wherein the at least one crimped portion (60) is arranged on the housing (14) so as to extend through 360° around the fluid port (24), or in that at least three crimped portions (60) are arranged in particular in a symmetrically distributed manner around the fluid port (24), said crimped portions (60) being arranged so as to extend in each case through 120° around the fluid port (24).

In some embodiments, the housing (14) and the fluid port (24) are fastened together by at least one peened-over portion (62) that applies a fastening force to the screw connection (28), wherein in particular a plurality of peened-over portions (62) that are arranged symmetrically around the fluid port (24) are provided.

As another example, a fuel injection system (10), in particular a gasoline fuel injection system, may include a high-pressure fuel pump (12) as described above and a line (40) for conducting fuel in the fuel injection system (10), wherein the line (40) is connected to a fluid port (24) of the high-pressure fuel pump (12), in particular screwed thereto, such that a screw drive (44), via which the fluid port (24) can be acted on in order to be screwed into a port receiving bore (30) of a housing (14) of the high-pressure fuel pump (12), is concealed.

### BRIEF DESCRIPTION OF THE DRAWINGS

Various configurations of the teachings herein are explained in more detail in the following text with reference to the appended drawings, in which:

FIG. 1 shows a sectional illustration of a subregion of a fuel injection system in the region of a high-pressure fuel pump having a fluid port arranged therein and a line, according to teachings of the present disclosure;

FIG. 2 shows a longitudinal-sectional illustration through the high-pressure fuel pump from FIG. 1 with the fluid port arranged thereon;

FIG. 3 shows an enlarged sectional illustration through the fluid port from FIG. 2 on a housing of the high-pressure fuel pump in a first embodiment;

FIG. 4 shows a sectional illustration through the fluid port from FIG. 3 along the line III-III in a first embodiment;

FIG. 5 shows a sectional illustration through the fluid port from FIG. 3 along the line III-III in a second embodiment;

FIG. 6 shows a sectional illustration of the fluid port from FIG. 2 on the housing of the high-pressure fuel pump in a second embodiment, according to teachings of the present disclosure; and

FIG. 7 shows a sectional illustration of the fluid port from FIG. 2 on the housing of the high-pressure fuel pump in a third embodiment, according to teachings of the present disclosure.

### DETAILED DESCRIPTION

Some embodiments may include a high-pressure fuel pump for applying high pressure to a fuel in a fuel injection system has a housing having a pressure chamber in which high pressure is applied to the fuel, and a fluid port for conducting fuel to the pressure chamber or away from the pressure chamber. The fluid port has an internal bore which is fluidically connected to the pressure chamber. The high-pressure fuel pump also has a port receiving bore in the housing for receiving the fluid port, wherein the fluid port is fastened in the port receiving bore by a screw connection. In some embodiments, there is a screw drive, via which the fluid port can be acted on in order to be screwed into the port receiving bore, wherein the screw drive is arranged in the internal bore of the fluid port.

Previously, the screw drive was provided externally on the fluid port, for example by providing an external hex on the fluid port. By contrast, it is now proposed that such an external screw drive be replaced by an internal drive and thus that the internal bore of the fluid port, which normally has the sole function of conducting the fuel to or away from the pressure chamber, be assigned a further function in the form of the screw drive. This existing internal bore, through which the fuel flows, is accordingly assigned a further task, namely that of providing the screw drive via which the fluid port can then be screwed into the port receiving bore.

As a result of the use of a screw drive, through which flow passes, in the internal bore, it is harder to take apart the high-pressure fuel pump, since the screw drive is concealed in the assembled state and is invisible at first glance. In addition, the use of the internal screw drive makes it possible to save the costs for an otherwise used external drive, since the corresponding installation space is already available without this external drive. It is possible to reduce the envelope dimensions of the fluid port and, inter alia, also to shorten the component overall, this resulting in a reduction in the raw material used and ultimately, as a result, also in a reduction in the component costs. A known assembly method for the high-pressure fuel pump therefore becomes more robust and cost-effective than previously known.

In some embodiments, the fluid port is a high-pressure port for guiding fuel, to which high pressure has been applied in the pressure chamber, to elements of the fuel injection system that are located downstream of the high-pressure fuel pump. In particular the high-pressure port on a high-pressure fuel pump may be loaded by higher system pressures, i.e. by a greater high pressure, which is generated in the fuel, for which reason in particular the high-pressure port is fastened to the housing as a screwed high-pressure port rather than as a welded high-pressure port. For this reasons, the screw drive, via which the high-pressure port is acted on in order to be screwed onto the housing of the high-pressure fuel pump, may be arranged in the internal bore of the high-pressure port. In some embodiments, in addition to the high-pressure port, there may be a low-pressure port provided on the housing of the high-pressure fuel pump with this internal screw drive, when it is fastened to a housing via a screw connection.

In some embodiments, the fluid port has a contact region for making contact with a wall of the port receiving bore and a line region for forming a line for guiding the fuel. In this case, the internal bore forms a collection volume for collecting fuel in the contact region, and a line bore in the line region. In this case, the screw drive is arranged in a manner integrated into the line bore. In some embodiments, the collection volume is arranged in the contact region and intended to receive highly pressurized fuel from the pressure chamber.

In the collection volume, the internal bore of the fluid port accordingly has a larger inside diameter than in the line bore. A collection volume having an adjoining line bore may provide increases in terms of flow and more suitable than a direct arrangement of a line bore at the pressure chamber of the high-pressure fuel pump, since in this way highly pressurized fuel is guided fluidically in a slightly slowed manner into the line region of the fluid port. In some embodiments, the screw drive is integrated into this line region, i.e. into the line bore, since in this way easier engagement from the outside is possible when assembling the high-pressure fuel pump.

In some embodiments, in the contact region, the fluid port has, on its outer side, an external thread for cooperating with an internal thread arranged in the port receiving bore, wherein the fluid port is formed with a smooth outer wall without an engagement surface, and in particular in a cylindrical manner, in the line region. When the fluid port is mounted in the port receiving bore, the external thread of the fluid port is screwed into the internal thread of the port receiving bore and is thus inaccessible from the outside following assembly. If the fluid port now has a smooth outer wall in the region protruding from the port receiving bore, the fluid port is protected against being acted on from the outside, since there is no engagement surface on which a tool could be placed. Therefore, the outer wall may be formed not only in a smooth manner but also in a cylindrical manner.

In some embodiments, the outer wall may have a coating for accommodating torsional forces, for example an adhesive application, which can accommodate, or compensate, torques even during assembly.

In some embodiments, the screw drive in the internal bore is configured as a polygonal socket, in particular as a hex socket, or as a lobular socket, in particular as a hexalobular socket. When the existing internal bore of the fluid port is used for a further purpose, namely in order to transmit a torque to the screw connection between the fluid port and port receiving bore, a geometrically rounded form, for example the hexalobular socket, is most suitable. Resulting therefrom are a screw drive that is not apparent from outside and protects against misuse, and also the smaller design, which results in a cost reduction.

In some embodiments, an insert has been inserted into the screw drive, which has a smooth inner surface, for example a cylindrical inner surface. For example, this can be an element which engages in a form-fitting manner in the hexalobular socket mentioned by way of example, such that the hexalobular socket is rendered unusable by this additional insert after mounting on the high-pressure fuel pump.

In some embodiments, the housing and the fluid port are fastened together by at least one crimped portion that applies a fastening force to the screw connection. For example, in this case, the crimped portion is arranged on the housing so as to extend through 360° around the fluid port. In some embodiments, at least three crimped portions may be arranged in a symmetrically distributed manner around the fluid port, said crimped portions being arranged so as to extend in each case through 120° around the fluid port.

In some embodiments, the housing and the fluid port may be fastened together by at least one peened-over portion that applies a fastening force to the screw connection. For example, it is possible in this case to provide a plurality of peened-over portions, for example one to six peened-over portions, that are arranged symmetrically around the fluid port.

In some embodiments, a crimped portion or a peened-over portion can therefore be introduced at the screw connection, such that the fluid port is secured against twisting. As a result of the use of a crimped portion or peened-over portion on the housing, the fluid port is secured in the high-pressure fuel pump and is thus secured against twisting or loosening with respect to a mating screw fitting of for example a high-pressure line. As a result, it is possible to dispense with the use of adhesives or coatings, thereby allowing a more robust and cleaner production process. In some embodiments, by providing a weld instead of a crimped portion or peened-over portion, there is a twist prevention means.

Some embodiments may include a fuel injection system, in particular a gasoline fuel injection system, with an above-described high-pressure fuel pump and a line for conducting fuel in the fuel injection system, wherein the line is connected to a fluid port of the high-pressure fuel pump, and in particular screwed thereto, such that a screw drive, via which the fluid port can be acted on in order to be screwed into a port receiving bore of a housing of the high-pressure fuel pump, is concealed. At first glance, the screw drive therefore remains invisible and is protected against misuse.

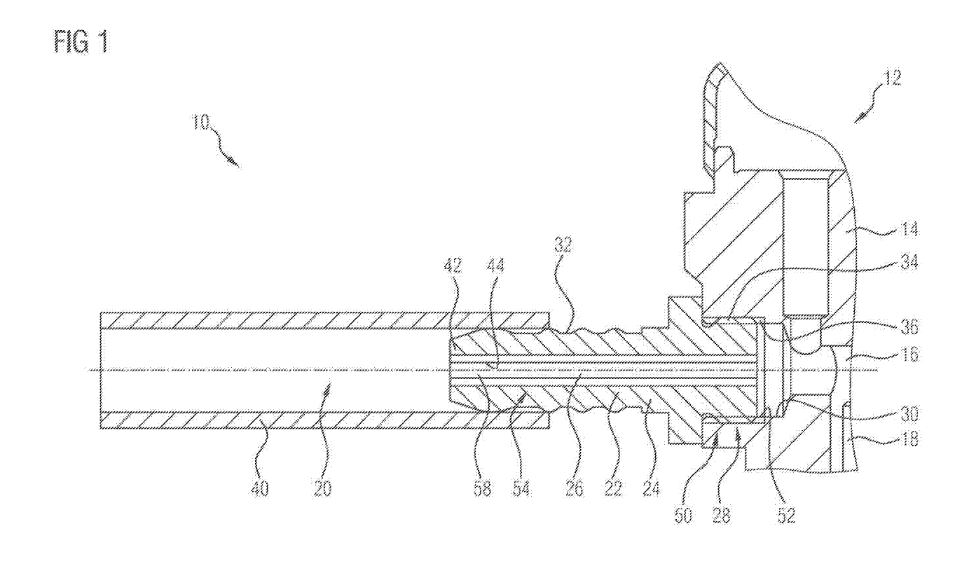

FIG. 1 shows a sectional illustration through a subregion of a fuel injection system 10, with which a fuel, for example gasoline, can be injected into combustion chambers of an internal combustion engine. The subregion of the fuel injection system 10 comprises a high-pressure fuel pump 12 for applying high pressure to the fuel.

The high-pressure fuel pump 12 has a housing 14 in which a pressure chamber 16 is located, in which a pump piston 18 moves back and forth in translation in order to periodically compress and relieve the pressure on a fuel arranged in the pressure chamber 16.

The pressure chamber 16 is supplied with fuel from a low-pressure region 20, wherein a low-pressure port 22 is fastened as fluid port 24 to the housing 14 of the high-pressure fuel pump 12. The fluid pump 24 has an internal bore 26 which is fluidically connected to the pressure chamber 16.

In order to realize a high-pressure proof connection between the fluid port 24 and housing 14 of the high-pressure fuel pump 12, the fluid port 24 and the housing 14 are connected together via a screw connection 28, meaning that the fluid port 24 is received in a port receiving bore 30 of the housing 14, wherein the fluid port 24 has an external thread 34 on an outer side 32, and wherein the port receiving bore 32 comprises an internal thread 36, wherein, when the fluid port 24 is mounted, the external thread 34 is screwed into the internal thread 36. In FIG. 1, the fluid port 24 is configured as a low-pressure port 22, which leads to the low-pressure region 30.

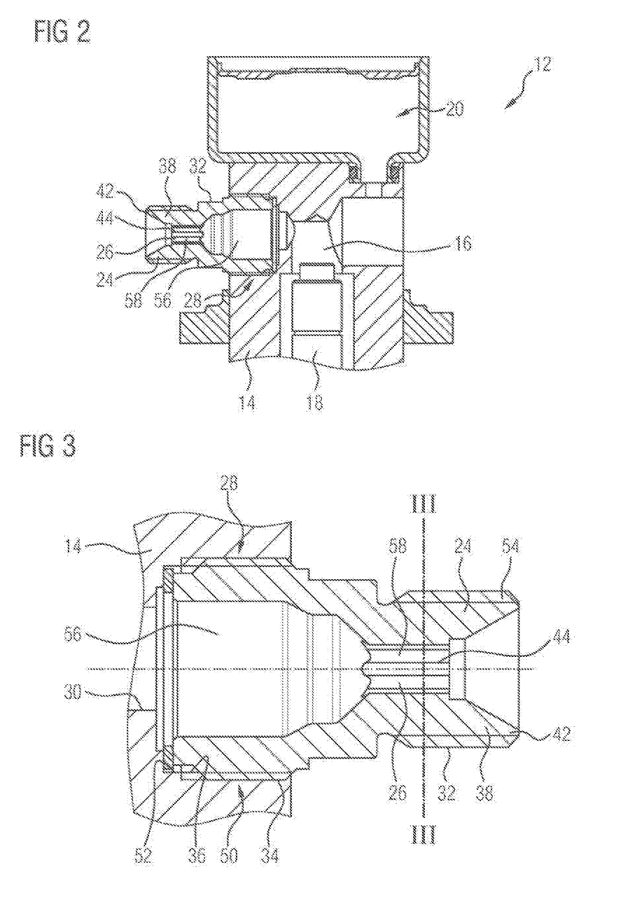

FIG. 2 shows the high-pressure fuel pump 12 in a longitudinal-sectional illustration, wherein the fluid port 24 is embodied as a high-pressure port 38, via which fuel, to which high pressure has been applied in the pressure chamber 16, can be guided to elements of the fuel injection system 10 which are located fluidically downstream of the high-pressure fuel pump 12. The high-pressure port 38, too, is connected to the housing 14 of the high-pressure fuel pump 12 via a screw connection 28.

Schematically illustrated only in FIG. 1, but also existing at the high-pressure port 38 in FIG. 2, is a line 40, which is connected to the respective fluid port 24, for example by screwing, in order to conduct the fuel either to the low-pressure port 22 or away from the high-pressure port 38. The line 40 is in this case connected to the respective fluid port 24 such that an end 42 of the fluid port 24 which is not received in the port receiving bore 30 is concealed.

The respective fluid port 24—low-pressure port 22 or high-pressure port 38—is connected to the housing 14 of the high-pressure fuel pump 12 in each case via a normally releasable screw connection 28, and therefore there is the risk of the high-pressure fuel pump 12 being able to be tampered with at this screw connection 28 in the installed state. In order to prevent this, a screw drive 44, via which the fluid port 24 is acted on and can be screwed into the port receiving bore 30, is provided not, as is usually conventional, on the outer side 32 of the fluid port 24 but in the internal bore 26.

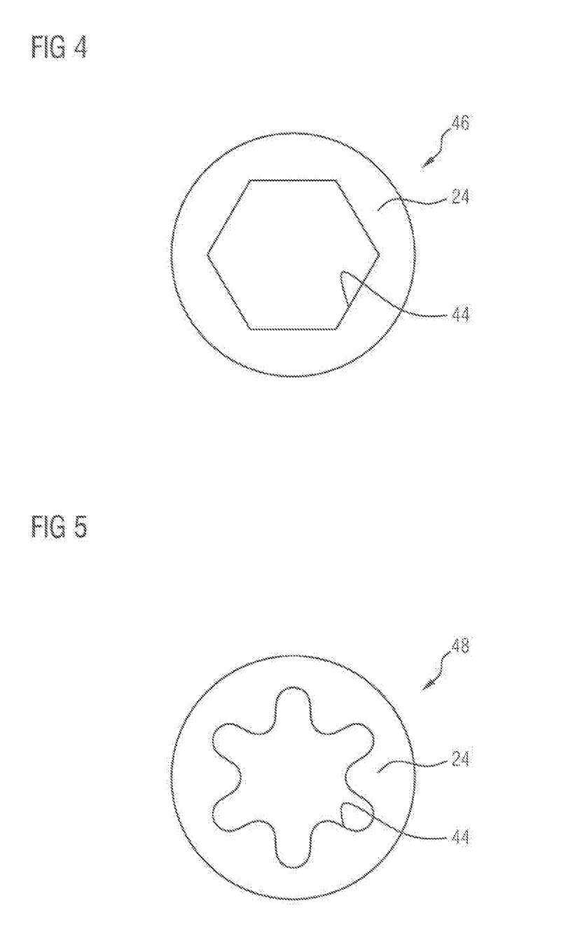

This can be seen in the sectional view in FIG. 3. In this case, as can be seen in a sectional view, shown in FIG. 4, along the line III-III in FIG. 3, the screw drive 44 can be embodied as a hex socket 46 or, as can be seen in FIG. 5, as a hexalobular socket 48.

The fluid port 24 has two regions, namely a contact region 50, by way of which it makes contact with a wall 52 of the port receiving bore 30 in an installed state, and in which the external thread 34 is arranged, and a line region 54, which forms a line for guiding the fuel. Within the contact region 50, the internal bore 26 is configured such that it forms a collection volume 56 for collecting the fuel. In the line region 54, the internal bore 26 is configured such that it forms a line bore 58. In order for it to be possible to readily act on the screw drive 44 with a tool from the outside during the mounting of the fluid port 24, the screw drive 44 is arranged advantageously in the line bore 58. As a result, the line bore 58 now takes on two tasks, namely that of conducting the fuel and that of providing the screw drive 44 for mounting the fluid port 24.

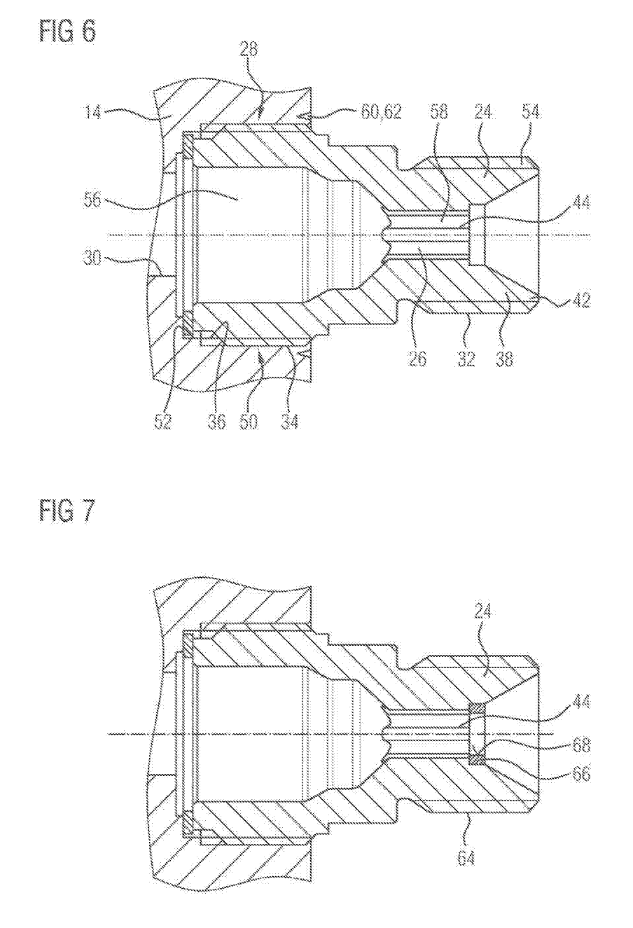

FIG. 6 shows a sectional illustration of a second embodiment of the fluid port 24 from FIG. 2, wherein, in addition to the internal screw drive 44, a crimped portion 60 is additionally arranged in a manner extending around the fluid port 24, said crimped portion 60 applying a fastening force to the screw connection 28 between the port receiving bore 30 and fluid port 24. As an alternative to the crimped portion 60, it is also possible to provide a peened-over portion 62, which has the same effect. As a result of the use of such a crimped portion 60 or peened-over portion 62 on the housing 14, the fluid port 24 is secured in the assembly and is thus secured against twisting or loosening with respect to a mating screw fitting starting from a line 40.

Depending on the requirements, it is possible in this case for a crimped portion 60 to be selected which is arranged in a manner extending 360° around the fluid port 24, but it is also possible to construct the crimped portion 60 from a plurality of part-segments, for example three crimped portions, which are arranged in a manner distributed in each case through 120° around the fluid port 24. Other symmetrical distributions of shorter crimped portions 60 around the fluid port 24 are also possible. Likewise, it is possible, in the case of a peened-over portion 62 around the fluid port 24, to arranged a plurality of individual peened-over portions, for example one to six peened-over portions 62. In some embodiments, the fluid port 24 includes, on its outer side 32, in particular in the region in which it is not received in the port receiving bore 30, a coating 64, which can likewise prevent misuse.

FIG. 7 shows a third embodiment of the fluid port 24 in a sectional illustration, wherein an insert 66 has additionally been introduced into the screw drive 44, said insert 66 having a smooth inner face 68 in order in this way to make the screw drive 44 unusable. The insert 66 is in this case configured such that it engages in a form-fitting manner in the screw drive 44, i.e. for example in a hexalobular socket 48.

What is claimed is:

1. A fuel pump for applying pressure to a fuel in a fuel injection system, the fuel pump comprising:
a housing with a pressure chamber in which pressure is applied to the fuel;
a fluid port for conducting fuel to the pressure chamber or away from the pressure chamber;
wherein the fluid port has an internal bore fluidically connected to the pressure chamber;
a port receiving bore in the housing for receiving the fluid port;
wherein the fluid port is fastened in the port receiving bore with a screw connection; and
a screw drive arranged in the internal bore of the fluid port,
via which the fluid port can be acted on in order to be screwed into the port receiving bore.

2. The fuel pump as claimed in claim 1, wherein the fluid port comprises a high-pressure port for guiding fuel from the pressure chamber to elements of the fuel injection system located downstream of the fuel pump.

3. The fuel pump as claimed in claim 1, wherein the fluid port includes:
a contact region in contact with a wall of the port receiving bore; and
a line region forming a line for guiding the fuel;
wherein the internal bore forms a collection volume for collecting fuel in the contact region;
the internal bore forms a line bore in the line region; and
the screw drive is integrated into the line bore.

4. The fuel pump as claimed in claim 3, wherein:
in the contact region, the fluid port includes, on its outer side, an external thread for mating with an internal thread in the port receiving bore; and
the fluid port comprises a smooth outer wall without an engagement surface in the line region.

5. The fuel pump as claimed in claim 4, wherein the outer wall includes a coating accommodating torsional forces.

6. The fuel pump as claimed in claim 1, wherein the screw drive comprises a polygonal socket.

7. The fuel pump as claimed in claim 6, further comprising an insert in the screw drive, the insert having a smooth inner surface.

8. The fuel pump as claimed in claim 1, wherein:
the housing and the fluid port are fastened together by a crimped portion applying a fastening force to the screw connection; and
at least three crimped portions are arranged in a symmetrically distributed manner around the fluid port extending through 120° around the fluid port.

9. The fuel pump as claimed in claim 1, wherein the housing and the fluid port are fastened together by a plurality of peened-over portions applying a fastening force to the screw connection, the plurality of peened-over portions arranged symmetrically around the fluid port.

10. A fuel injection system comprising:
a fuel pump and a line for conducting fuel in the fuel injection system, the fuel pump comprising:
a housing with a pressure chamber in which pressure is applied to the fuel;
a fluid port for conducting fuel to the pressure chamber or away from the pressure chamber;
wherein the fluid port has an internal bore fluidically connected to the pressure chamber;
a port receiving bore in the housing for receiving the fluid port;
wherein the fluid port is fastened in the port receiving bore with a screw connection; and
a screw drive arranged in the internal bore of the fluid port,
via which the fluid port can be acted on in order to be screwed into the port receiving bore;
wherein the line is connected to the fluid port concealing the screw drive.

11. The fuel pump as claimed in claim 1, wherein the housing and the fluid port are fastened together by three crimped portions applying a fastening force to the screw connection, the three crimped portions arranged in a symmetrically distributed manner, so as to extend in each case through 120° around the fluid port.
